(19) United States
(12) Patent Application Publication
(10) Pub. No.: US 2012/0025019 A1
(43) Pub. Date: Feb. 2, 2012

(54) Vehicle Seat with Reclining Back and Leg Rest

(76) Inventors: James Dominic France, Auckland (NZ); Amitai Halfon, Auckland (NZ)

(21) Appl. No.: 13/147,035

(22) PCT Filed: Jan. 29, 2010
(86) PCT No.: PCT/IB10/50399

§ 371 Date: Oct. 13, 2011

Related U.S. Application Data
(60) Provisional application No. 61/202,127, filed on Jan. 30, 2009.

(51) Int. Cl. B64D 11/06; B60N 2/46; B60N 2/22; B60N 2/02; B60N 2/01

(52) U.S. Cl. 244/118.6; 297/68

(57) ABSTRACT

A passenger vehicle seat comprising, a seat back, a seat pan and a leg rest supported by a support frame, the leg rest of each seat moveably mounted relative to the support frame in a manner to allow it to move between (a) a stored position and (b) a fully deployed position where the seat pan and the leg rest are substantially coplanar, and wherein the seat pan is configurable between a substantially horizontal position, and one or more selected from an inclined and reclined position, and wherein the leg rest and the seat pan are coupled via an articulated coupling, so that movement of at least one selected from the leg rest and seat pan can cause movement of the other of the leg rest and seat pan.

### FIELD OF INVENTION

The present invention relates to seats and seating arrangements in or for a vehicle, particularly but not solely for an aircraft.

### BACKGROUND

Accommodation of passengers on an aircraft requires a balance of many variables. Most aircraft seats and seating systems have been developed to incorporate and focus on one concept to increase the passengers comfort i.e. the reclining seat, with little consideration of incorporating alternative comfort increasing features. It is desirable to have a seating system that includes a variety of seating improvements and features that increase a passenger's comfort and provide an adaptable seating system for one or multiple users.

For an aircraft seat or seating system that does incorporate a variety of seating concepts it is desirable that any functions and or reconfigurations of that seat work in cooperation with other functions and reconfigurations of that or other seats.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

As used herein the term “and/or” means “and” or “or”, or both.

As used herein “(s)” following a noun means the plural and/or singular forms of the noun.

“contiguous” as used herein may be interpreted as being an abutting and contacting relationship or a non abutting relationship where a small but negligible gap may exist.

“window seat” as used herein denotes a seat of a row that is closest to the cabin wall adjacent the fuselage, whether there is physically a window adjacent that seat or not.

### BRIEF DESCRIPTION OF THE INVENTION

In a first aspect the present invention may broadly be said to be a passenger vehicle seat comprising:
a seat back, a seat pan and a leg rest supported by a support frame, the leg rest of each seat moveably mounted relative to the support frame in a manner to allow it to move between (a) a stored position and (b) a fully deployed position where the seat pan and the leg rest are substantially coplanar, and
wherein the seat pan is configurable between a substantially horizontal position, and one or more selected from an inclined and reclined position,
and wherein the leg rest and the seat pan are coupled via an articulated coupling, so that movement of at least one selected from the leg rest and seat pan can cause movement of the other of the leg rest and seat pan.

Preferably the at least one seat is one of a plurality of adjacent seats in a row.

Preferably all the seats in the row are as herein described.

Preferably, the articulated coupling is configured to allow independent movement of the seat pan when the leg rest is in any position.

Preferably, the leg rest includes a substantially planar passenger support surface.

Preferably, the leg rest is moveable to a partially deployed position in which the plane of the leg rest is aligned in a range of between 30 and 60 degree to the vertical.

Preferably, the leg rest is moveable to a partially deployed position in which the plane of the leg rest is aligned in a position corresponding to about 45 degrees to the vertical.

Preferably, the articulated coupling is configured to align the seat pan in one selected from a reclined position and inclined position when the leg rest is between its fully deployed position and stored position.

Preferably, the articulated coupling is configured so that movement of the leg rest to a position corresponding to about 45 degrees to the vertical results in movement of the seat pan to a reclined position.

Preferably, the articulated coupling is configured to be moved by at least one electric motor.

Preferably, the articulated coupling is configured to be moved manually by a person.

Preferably, the articulated coupling is configured to be moved by manual application of a force to the leg rest.

Preferably, the leg rest is articulated about a leg rest pivot axis.

Preferably, the articulated coupling includes a coupling pivoting member pivotable about a coupling pivot axis.

Preferably, the articulated coupling includes a coupling pivoting member pivotable about a horizontal coupling pivot axis.

Preferably, the coupling pivoting member is coupled to the leg rest by a first sliding mechanism.

Preferably, the first sliding mechanism includes a first lug configured and dimensioned to be received into and move along a complementary first slot formation.

Preferably, the leg rest includes a leg rest frame and a leg rest cushion.

Preferably the leg rest cushion defines the substantially planar passenger support surface.

Preferably, the first lug of the first sliding mechanism extends from the leg rest frame, and is received into the first slot formation in the coupling pivoting member.

Preferably, the pivoting movement of leg rest about the leg rest pivot axis causes pivoting movement of the pivoting member about the coupling pivot axis.

Preferably, the pivoting movement of leg rest about the leg rest pivot axis causes sliding movement of the first lug in the first slot formation.

Preferably, the coupling pivoting member is coupled to the seat pan by a second sliding mechanism.

Preferably, the second sliding mechanism includes a second lug configured and dimensioned to be received into and move along a complementary dimensioned second slot formation.

Preferably, the seat pan includes a seat pan cushion and a seat pan frame.

Preferably, the seat pan cushion defines a supporting surface.

Preferably, the second lug of the second sliding mechanism extends from the coupling pivoting member and is received into the second slot formation in the seat pan frame.

Preferably, the seat pan frame is pivotally mounted to the support frame about a seat pan pivoting axis.

Preferably the pivoting movement of the coupling pivoting member about the coupling pivot axis causes sliding movement of the second lug in the second slot formation.

Preferably, the sliding movement of the second lug in the second slot formation causes pivoting movement of the seat pan about the seat pan pivoting axis.

Preferably, the seat arrangement includes a locking mechanism for locking in position one or more selected from the seat pan, the leg rest, the articulated coupling, and the coupling pivoting member.

Preferably, the locking mechanism is configured to lock any one or more selected from the seat pan, the leg rest, the articulated coupling, and the coupling pivoting member at any position within their ranges of movement.

Preferably, the seat back is moveable between a more upright and a more reclining position.

Preferably, the seat back is independently moveable between an upright and a reclining position from the leg rest movement.

Preferably, the seat back is configured and adapted to be moved to its reclining position when the seat pan is in its reclining position.

Preferably the leg rest and seat pan of each seat in the row can cooperate to define a reconfigurable horizontal support surface for at least one passenger.

Preferably the row comprises three adjacent seats.

Preferably the row comprises four adjacent seats.

Preferably the row comprises five adjacent seats.

Preferably for each seat, the leg rest extends from adjacent the seat pan and in the seat facing direction when in the fully deployed position.

Preferably the support frame supports all seats of said row.

Preferably the seat back of each seat can move between an upright position and a reclined position.

Preferably each said leg rest is supported solely by the support frame.

Preferably each said leg rest can be moved to and be held at a partially deployed position that is intermediate of the fully deployed and stowed positions.

Preferably the passenger vehicle seating unit as herein above described is installed onboard a commercial passenger aircraft.

Preferably the passenger vehicle seating unit as herein above described is installed in an economy class section of the aircraft.

Preferably the passenger vehicle seating unit as herein above described is installed in a class section of the aircraft that offers the lowest standard fare price per seat to customers.

Preferably, the seat arrangement further includes at least one arm rest.

Preferably, the arm rest is pivotable about a horizontal axis between,
a deployed position in which it is available for use as an arm rest; and
a stowed position in which it is moved at least partially out of the way of users sitting in that seat.

Preferably, the seat arrangement includes a cavity in the seat back for at least partially receiving the arm rest when it is in its stowed position.

Preferably the leg rest and seat pan of each seat in the row can cooperate to define a reconfigurable support surface for shared use by at least two passengers.

In a second aspect the present invention may broadly be said to be a passenger vehicle seating arrangement comprising:
A row of a plurality of adjacent seats, each including a seat back, a seat pan and a leg rest supported by a support frame, the leg rest of each seat moveably mounted relative to the support frame in a manner to allow it to move between (a) a stored position and (b) a fully deployed position where the seat pan and the leg rest are substantially coplanar, and
wherein the seat pan is configurable between a substantially horizontal position, and one or more selected from an inclined and reclined position,
and wherein the leg rest and the seat pan are coupled via an articulated coupling, so that movement of at least one selected from the leg rest and seat pan can cause movement of the other of the leg rest and seat pan.
Preferably the seats are as herein previously described

According to a further aspect, the invention may be said to consist in a seating system suitable for a passenger vehicle, said seating system comprising

a seating arrangement with seats as herein described.

According to a further aspect, the invention may be said to consist in a passenger vehicle comprising a seat unit as described above.

According to a further aspect, the invention may be said to consist in a passenger vehicle comprising a seating system as described above.

In a further aspect the present invention may be said to consist in a seating arrangement as herein described with reference to any one or more of the accompanying drawings.

In a further aspect the present invention consists in a seat as herein described with reference to any one or more of the accompanying drawings.

As used herein the term “and/or” means “and” or “or”, or both.

As used herein “(s)” following a noun means the plural and/or singular forms of the noun.

The term “comprising” or “including” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” and “include” and “included” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

Preferred embodiments of the present invention are shown in the accompanying drawings in which;

FIG. 1 shows a front perspective view of a seating arrangement with individual seats of the front row positioned in various configurations;

FIG. 2 shows a top view of a seating arrangement of FIG. 1;

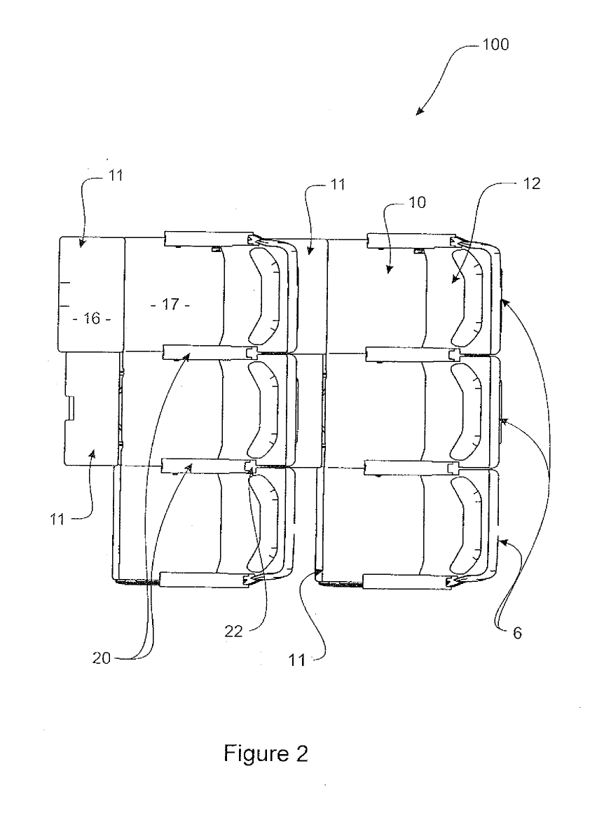

FIG. 3 shows a side view of a seating arrangement of FIG. 1;

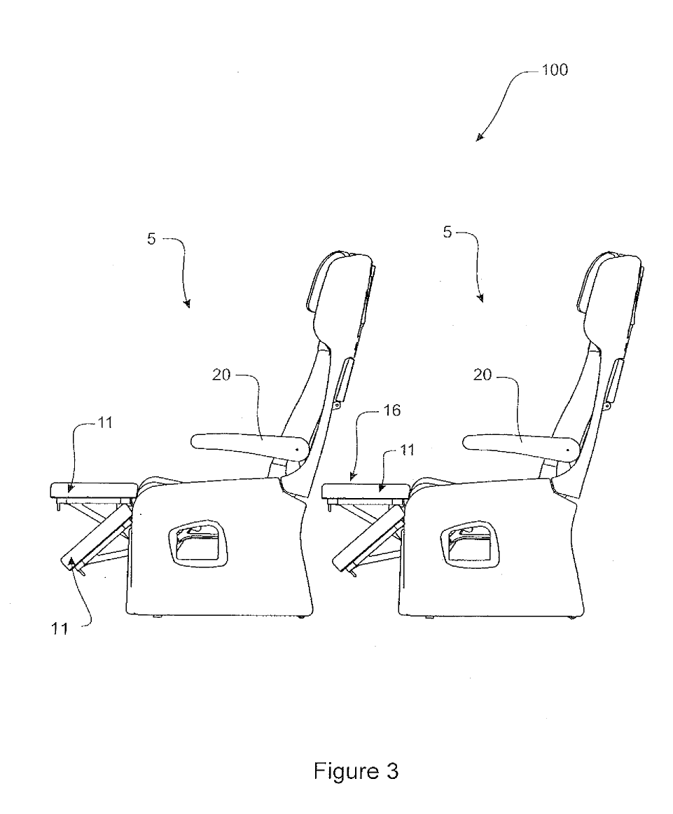

FIG. 4 shows a side view of the seat pan, leg rest and articulated coupling of a seat arrangement in a stowed condition;

FIG. 5 shows a side view of the seat pan, leg rest and articulated coupling of a seat arrangement in a partially deployed position;

FIG. 6 shows a side view of the seat pan, leg rest and articulated coupling of a seat arrangement in a fully deployed position; and

FIG. 7 is a perspective view of a passenger aircraft.

### DETAILED DESCRIPTION OF THE INVENTION

With reference to the above drawings, in which similar features are generally indicated by similar numerals, there is shown a seating arrangement 100.

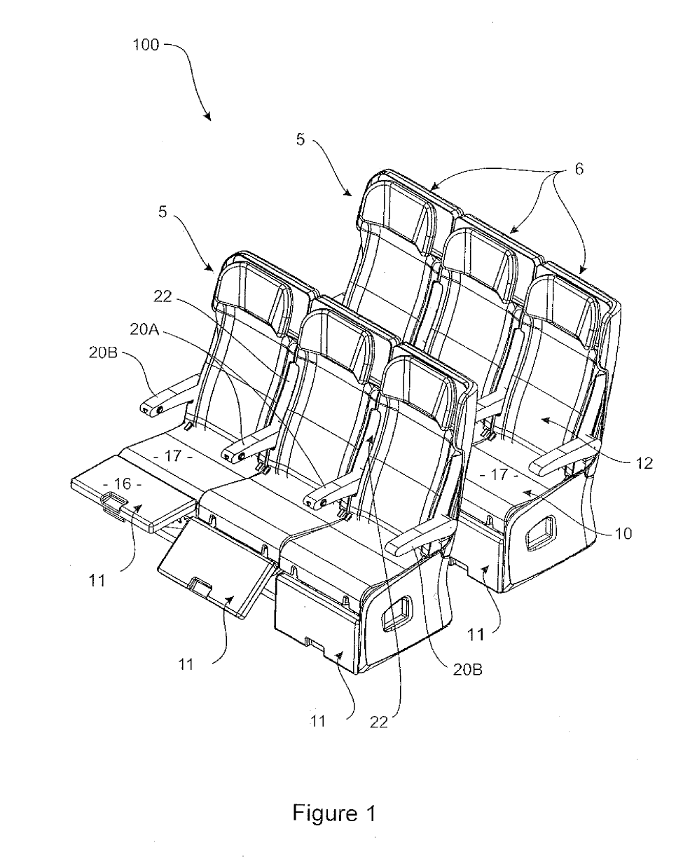

FIG. 1 shows a seating arrangement 100 that can be implemented on board a commercial passenger aircraft 300. In the preferred embodiment the seating arrangement is located in the economy class section of the aircraft. The seating arrangement 100 consists of at least one and preferably at least two rows 5 of seats 6 that are positioned one behind the other. Each row of seats 5 includes at least two and preferably at least three adjacent seats 6. Each seat 6 in a row 5 includes a seat back 12, seat pan 10 and preferably also a leg rest 11. In the preferred embodiment the seating arrangement 100 also includes at least one armrest 20 that may be located between each of the adjacent seats 6. Each seat 6 can receive a passenger in a sedentary position. Each seat 6 defines an individual space in the row 5 for a sedentary passenger to occupy. Such a passenger may occupy such a space and may utilise the seat back 12, seat pan 10 and leg rest 11. They may also use the arm rests 20 that may be presented on each side of the passenger. Arm rests 20 may be movable from an in use position where the arms of a passenger can rest on them, and a stowed position, where the arm rests generally are not located in the general space between the seat pans 10 and seat backs 12. The arm rests 20 may be removable, or may move down to be between seat pans 10 or move back to be between seat backs 12 of the row 5 of seats 6. For example the arm rests 20a may be moved to a stowed position where they extend substantially vertically and/or may be recessed within/or between the seat back 12 of adjacent seats 6 in that row 5.

The armrest(s) 20a can pivot between the deployed position and a stowed position about a horizontal axis and when in the stowed position are substantially out of the way of passengers. In the preferred embodiment the stowed position may be in a cavity 22 formed between two adjacent seat backs 12.

The outer most arm rests 20b may or may not be movable. However, they may be movable in a like manner to the arm rests 20a.

Each row 5 preferably faces in a forward direction in relation to the body of the aircraft 300. In other words, the seat back 12 faces toward the front of the aircraft 300. Each row 5 preferably faces in the same direction. A column of plurality of rows 5 can be defined in the aircraft 300, the column direction may be parallel to the seat 6 facing direction. And may be parallel to the elongate direction of the body of the aircraft 300.

The seats 6 in each row 5 are positioned adjacent each other The seat pans 10 are preferably able to assume a condition contiguous each other so that a bench or couch like sitting surface may be defined by the at least two seats. The seat backs 12 of each seat 6 may recline from an upright more position to a reclined more position. This can be achieved independent of the position of adjacent seat backs 12. The seats 6 may be individual seats 6 each separately mounted to the floor track or tracks of the aircraft 300 or may all be supported by one or more support frames (not shown) mounted to the floor track or tracks of the aircraft 300.

Preferably each row 5 has at least two adjacent seats 6, more preferably at least three seats 6 or four adjacent seats 6.

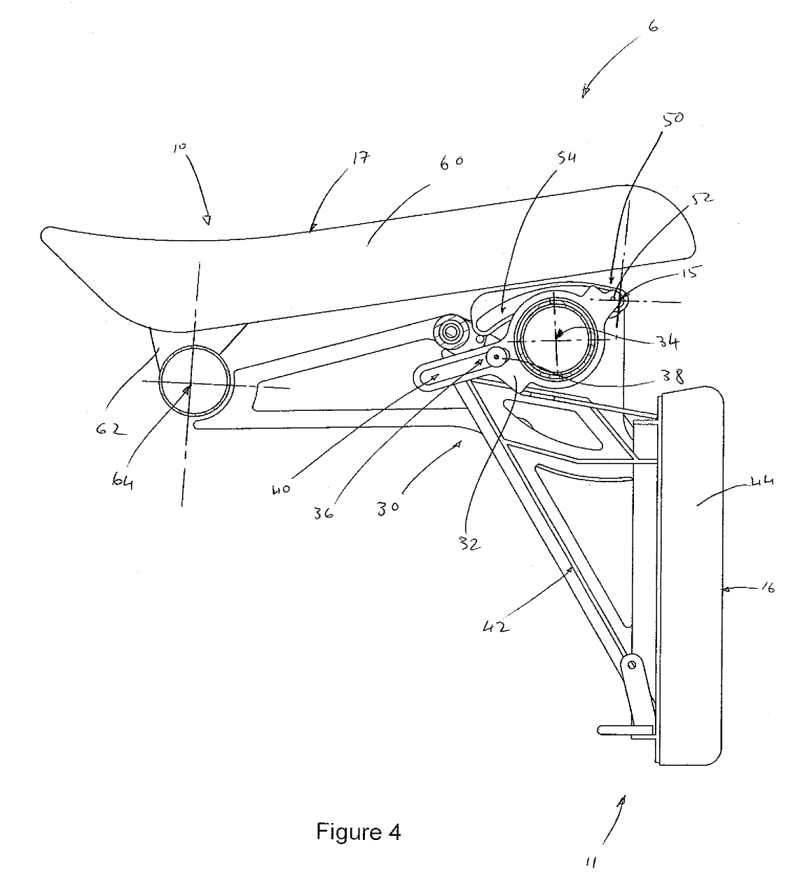

Referring now to FIGS. 4-6, each seat 6 comprises a seat back 12; a seat pan 10; a leg rest 11 and an articulated coupling 30.

The seat back 12 is configured to be independently moveable between a more upright position and a more reclined position.

The seat pan 10 includes a seat pan cushion 60 supported at least in part by a seat pan frame 62, and defines a supporting surface 17. The seat pan frame 62 is pivotally mounted to a fixed structural member (not shown) relative the aircraft 300 about a seat pan pivoting axis 64.

The seat pan 10 is configured to be moveable between a substantially horizontal position (as shown in FIGS. 4-6), and a reclined position in which the seat pan 10 slopes upwardly towards the front of the seat pan 10. It is also envisaged that in alternative embodiments, the seat pan 10 could also move to an inclined position in which the seat pan 10 slopes downwardly towards the front of the seat pan 10.

The leg rest 11 is substantially planar in a preferred embodiment, but it is envisaged that it could include formations or contouring on it. The leg rest 11 includes a leg rest frame 42 and a leg rest cushion 44 defining a supporting surface 16.

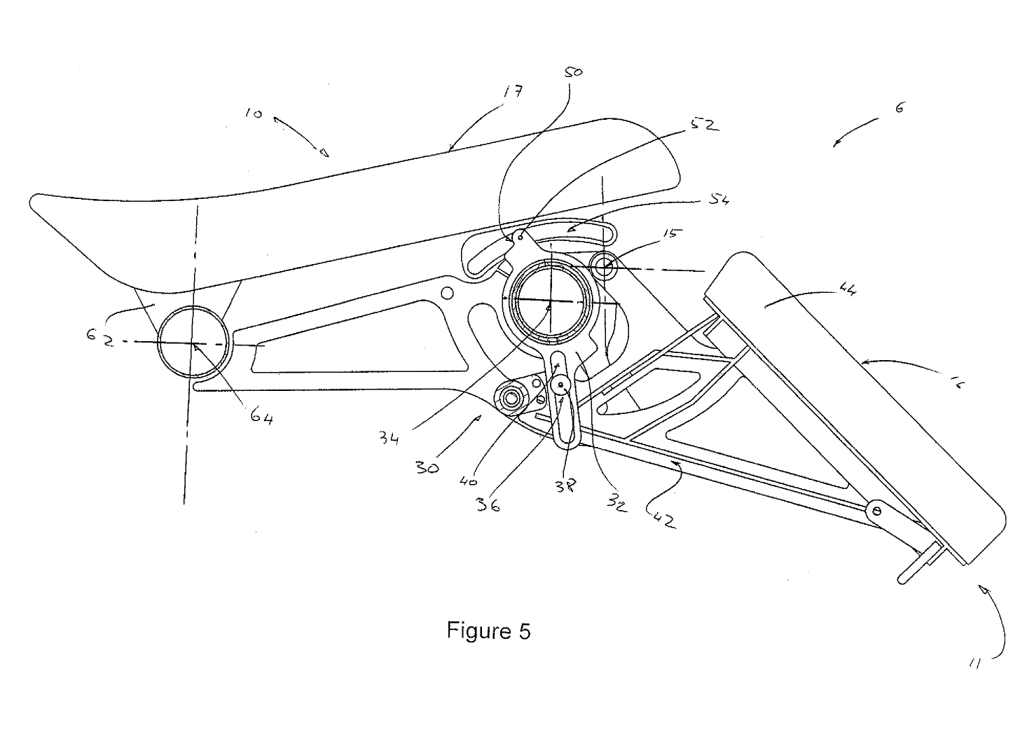

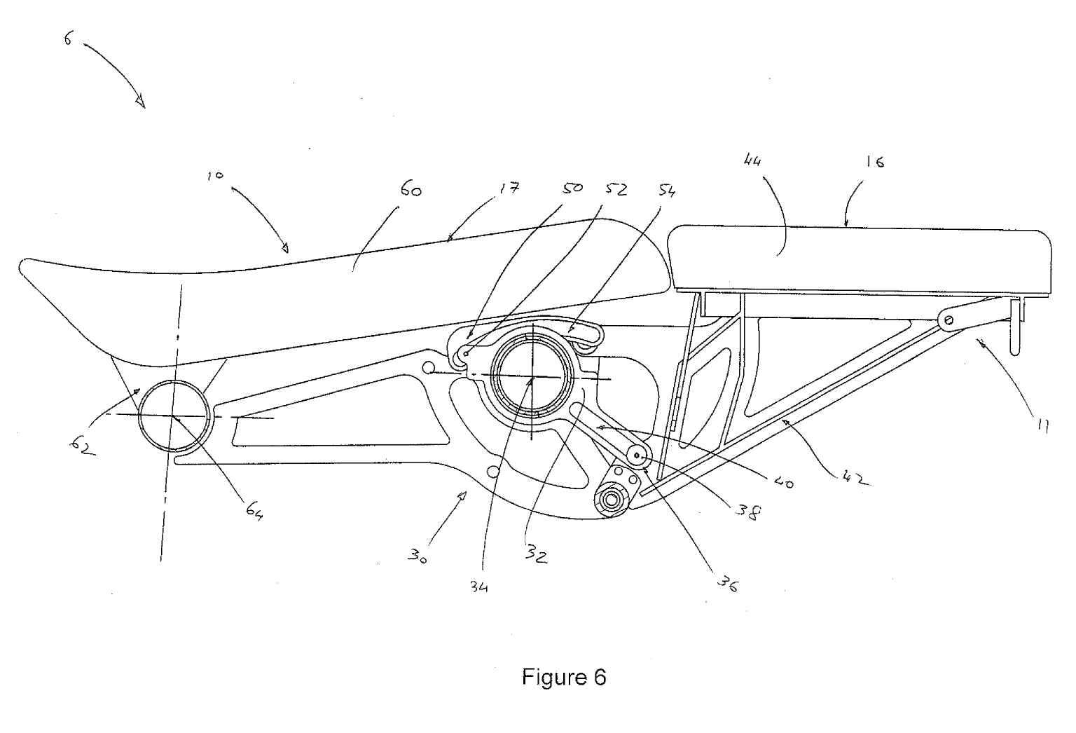

The leg rest 11 is articulated to pivot about a leg rest pivot axis 15 to be movable between a stored position (as shown in FIG. 4) and a fully deployed position (as shown in FIG. 6), and passing through a partially deployed position (as shown in FIG. 5). In the stored position, the leg rest 11 is stowed at least partially beneath the seat pan 10. In the fully deployed position, the leg rest 11 extends substantially outwardly from the seat pan 10 to sit co-planar with the seat pan 10. In the partially deployed position, it is envisaged that the plane of the leg rest 11 will be aligned in a range of between 30 and 60 degree to the vertical, and most preferably at about 45 degrees to the vertical.

The leg rest 11 and the seat pan 10 are coupled to each other via the articulated coupling 30. As will be explained in greater detail below, movement of at least one of the seat pan 10 or the leg rest 11 causes or can cause movement of the other of the seat pan 10 and the leg rest 11.

The articulated coupling 30 includes a coupling pivoting member 32, which is pivotable about a horizontal pivot axis 34. The coupling pivoting member 32 is coupled to the leg rest 11 by a first sliding mechanism 36. The first sliding mechanism 36 includes a first lug 38 which is slidingly received into and is reciprocatingly movable along a complementary first slot formation 40.

In a preferred embodiment, the first lug 38 extends from the leg rest frame 42, and is received into the first slot formation 40 in the coupling pivoting member 32. However, it is envisaged that other alternative mechanisms may be utilised to drive angular movement of the leg rest 11 about the leg rest pivot axis 15. In one embodiment, the leg rest pivot axis 15 and the coupling pivot axis 34 of the coupling pivoting member 32 may be coaxial. In yet another embodiment, the coupling pivoting member 32 may be joined with the leg rest 11.

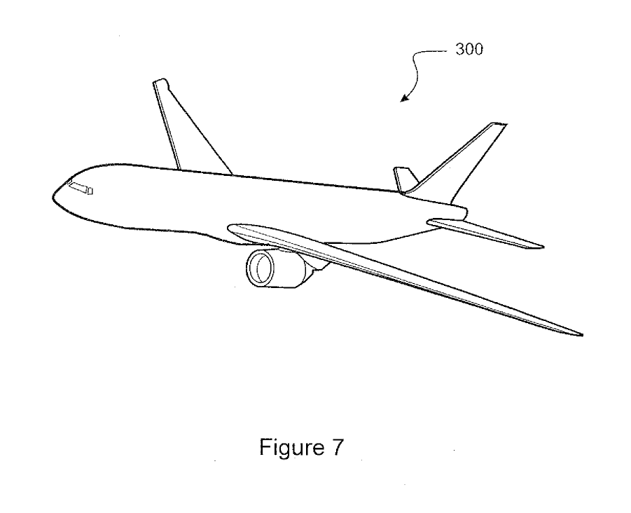

As shown in FIGS. 4-6, pivoting movement of the leg rest 11 about the leg rest pivot axis 15 causes pivoting movement of the coupling pivoting member 32 about the coupling pivot axis 34. Since the leg rest pivot axis 15 and the coupling pivot axis 34 are not coaxial in FIGS. 4-7, the first lug 38 will slide within in the first slot formation 40.

The coupling pivoting member 32 is further coupled to the seat pan 10 by a second sliding mechanism 50. The second sliding mechanism 50 includes a second lug 52 which extends from the coupling pivoting member 32, and is configured and dimensioned to be received into and slidingly move along a complementary second slot formation 54 in the seat pan frame 62. In this way, pivoting movement of the coupling pivoting member 32 about the coupling pivot axis 34 causes sliding movement of the second lug 52 in the second slot formation 54.

Further, sliding movement of the second lug 52 in the second slot formation 54 causes pivoting movement of the seat pan 10 about the seat pan pivoting axis 64, since the lug 52 acts as a cam follower and the second slot formation 54 acts as a cam. It is envisaged that many equivalent mechanical mechanisms may be used to transmit angular drive between the leg rest 11, and the seat pan 10.

It should be noted that the second slot formation 54 is curved in nature and extends downwardly at each end. This is because the seat pan 10 is required to be in its horizontal position when the leg rest 11 at least is in its fully deployed position and preferably is at both opposed limits of its pivotal movement. This is in order for the seat pan 10 to form a substantially coplanar surface with the substantially planar leg rest 11 when the leg rest 11 is in its fully deployed position, thereby defining a larger support surface for a passenger to sleep on than would have been the case without the leg rest 11.

Further, typically when an aircraft is about to land and/or take off, both the leg rest 11 may be required to be in its stored position, and the seat pan may be required to be in its horizontal position.

In the embodiments shown, the curvature of the second slot formation 54 is such that the greatest angle of recline of the seat pan 10 will occur when the plane of the leg rest 11 is between 30 and 60 degrees to the vertical, and preferably at about 45 degrees to the vertical.

It will be appreciated that while the embodiments shown in the figures show the seat pan 10 being directly coupled to the leg rest 11, it is envisaged that in alternative embodiments, the seat pan 10 may be decoupled and moved independently of the leg rest 11. In this way, the seat pan 10 can be moved to its reclined or inclined position when the leg rest 11 is in either its stored position, or in its fully deployed position.

It is envisaged that in one embodiment, the coupling pivoting member 32 may be configured and adapted to be pivoted about its coupling pivot axis 34 by at least one electric motor (not shown), thereby mechanising movement of the seat pan 10 and leg rest 11. However, for the purposes of airline seating, where weight is a critical factor, it is envisaged that the articulated coupling 30 will be manually moved by a user or passenger exerting a force for example to the leg rest 11 directly or via a handle (not shown) located towards an edge of the leg rest 11. Or by use of a hydrolock.

The seat 6 further includes a locking mechanism (not shown) for locking in selected positions one or more selected from the seat pan 10, the leg rest 11, the articulated coupling 30, and the coupling pivoting member 32. It is envisaged that the locking mechanism could operate by way of a positive mechanical lock, or a friction lock, or the like. It is envisaged that locking of the locking mechanism may occur passively (ie purely by virtue of the position of the leg rest), and unlocking actively (eg by a person).

Since the seat pan 10, the leg rest 11, the articulated coupling 30, and the coupling pivoting member 32 are coupled to each other, preventing movement of one of these will in effect lock the position of the rest of them, unless one or more of these is independently decoupled from the others as described.

It is envisaged that the locking mechanism could lock the one or more of the seat pan 10, the leg rest 11, the articulated coupling 30, and the coupling pivoting member 32 at predetermined positions (for example at its extremes of movement, and/or when the leg rest is at 45 degrees to the vertical) or allow locking of the leg rest 11 in variable positions.

It is envisaged that the seats are provided in an economy class section of an aircraft.

The accommodation space that can be created by the present invention provides a flexible and multifunctional space that can promote shared use of a defined space by multiple passengers. The space can be configured to treat passengers not as individuals but rather as groups of people such as a couple, a family of three, two business partners, 3 children and so on yet also cater for an individual traveler. And for that individual passenger offer more and multi functional space. Such as when for example the aircraft is not flying at full capacity or full class capacity.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1.-58. (canceled)

59. A passenger vehicle seat comprising:
a seat back, a seat pan and a leg rest supported by a support frame, the leg rest of each seat moveably mounted relative to the support frame in a manner to allow it to move between (a) a stored position and (b) a fully deployed position where the seat pan and the leg rest are substantially coplanar, and
wherein the seat pan is configurable between a substantially horizontal position, and one or more selected from an inclined and reclined position,
and wherein the leg rest and the seat pan are coupled via an articulated coupling, so that movement of at least one selected from the leg rest and seat pan can cause movement of the other of the leg rest and seat pan.

60. A passenger vehicle seat as claimed in claim 59 wherein the at least one seat is one of a plurality of adjacent seats in a row.

61. A passenger vehicle seat as claimed in claim 60 wherein all the seats in the row are as herein described.

62. A passenger vehicle seat as claimed in claim 59 wherein the articulated coupling is configured to allow independent movement of the seat pan when the leg rest is in any position.

63. A passenger vehicle seat as claimed in claim 59 wherein the leg rest includes a substantially planar passenger support surface.

64. A passenger vehicle seat as claimed in claim 59 wherein the leg rest is moveable to a partially deployed position in which the plane of the leg rest is aligned in a range of between 30 and 60 degree to the vertical.

65. A passenger vehicle seat as claimed in claim 59 wherein the articulated coupling is configured to align the seat pan in one selected from a reclined position and inclined position when the leg rest is between its fully deployed position and stored position.

66. A passenger vehicle seat as claimed in claim 59 wherein the articulated coupling is configured to be moved by manual application of a force to the leg rest.

67. A passenger vehicle seat as claimed in claim 59 wherein the articulated coupling includes a coupling pivoting member pivotable about a coupling pivot axis.

68. A passenger vehicle seat as claimed in claim 67 wherein the coupling pivoting member is coupled to the leg rest by a first sliding mechanism.

69. A passenger vehicle seat as claimed in claim 68 wherein the first sliding mechanism includes a first lug configured and dimensioned to be received into and move along a complementary first slot formation.

70. A passenger vehicle seat as claimed in claim 69 wherein the first lug of the first sliding mechanism extends from the leg rest frame, and is received into the first slot formation in the coupling pivoting member.

71. A passenger vehicle seat as claimed in claim 67 wherein the pivoting movement of leg rest about the leg rest pivot axis causes pivoting movement of the pivoting member about the coupling pivot axis.

72. A passenger vehicle seat as claimed in claim 67 wherein the seat arrangement includes a locking mechanism for locking in position one or more selected from the seat pan, the leg rest, the articulated coupling, and the coupling pivoting member.

73. A passenger vehicle seat as claimed in claim 59 wherein the seat back is moveable between a more upright and a more reclining position.

74. A passenger vehicle seat as claimed in claim 59 wherein the seat back is independently moveable between an upright and a reclining position from the leg rest movement.

75. A passenger vehicle seat as claimed in claim 59 wherein the leg rest and seat pan of each seat in the row can cooperate to define a reconfigurable horizontal support surface for at least one passenger.

76. A passenger vehicle seat as claimed in claim 60 wherein the row comprises three adjacent seats.

77. A passenger vehicle seat as claimed in claim 60 wherein the row comprises four adjacent seats.

78. A passenger vehicle seat as claimed in claim 59 wherein for each seat, the leg rest extends from adjacent the seat pan and in the seat facing direction when in the fully deployed position.

79. A passenger vehicle seat as claimed in claim 59 wherein the passenger vehicle seating unit as herein above described is installed onboard a commercial passenger aircraft.

80. A passenger vehicle seat as claimed in claim 59 wherein the seat arrangement further includes at least one arm rest.

81. A passenger vehicle seat as claimed in claim 80 wherein the arm rest is pivotable about a horizontal axis between,
a deployed position in which it is available for use as an arm rest; and
a stowed position in which it is moved at least partially out of the way of users sitting in that seat.

82. A passenger vehicle seat as claimed in claim 80 wherein the seat arrangement includes a cavity in the seat back for at least partially receiving the arm rest when it is in its stowed position.

83. A passenger vehicle seat as claimed in claim 59 wherein the leg rest and seat pan of each seat in the row can cooperate to define a reconfigurable support surface for shared use by at least two passengers.

84. A passenger vehicle seating arrangement comprising:
a row of a plurality of adjacent seats, each including a seat back, a seat pan and a leg rest supported by a support frame, the leg rest of each seat moveably mounted relative to the support frame in a manner to allow it to move between (a) a stored position and (b) a fully deployed position where the seat pan and the leg rest are substantially coplanar, and
wherein the seat pan is configurable between a substantially horizontal position, and one or more selected from an inclined and reclined position,
and wherein the leg rest and the seat pan are coupled via an articulated coupling, so that movement of at least one selected from the leg rest and seat pan can cause movement of the other of the leg rest and seat pan.
